(19) United States
(12) Patent Application Publication
(10) Pub. No.: US 2004/0222205 A1
(43) Pub. Date: Nov. 11, 2004

(54) Little sweetheart mini twenties

(76) Inventor: Rita Jean Carpenter, Natchitoches, LA (US)

Correspondence Address: Mrs. Rita Jean Carpenter, 1609 Washington Street, Natchitoches, LA, 71457, US

(21) Appl. No.: 10/428,916

(22) Filed: May 5, 2003

(51) Int. Cl. A45D 4/12; H05B 3/06

(52) U.S. Cl. 219/222; 219/521

(57) ABSTRACT

A hair curling roller system having a plurality of post members having the same outer diameter for heating the rollers and a plurality of rollers having inner cavities for mounting the rollers on the posts with such inner cavities have substantially the same inner diameters. There is only one group of rollers, with all having the same outer diameter, being approximately ¾″. Each of the curling rollers include an interior core member having an opening in one lateral end of the core member and longitudinally extending within the core member; this core member is formed of a material highly conductive of heat. An elongated metal sleeve is positioned within the opening of the core member of each roller and is attached to the inside of such core member. In each roller the interior core has a central hub and a plurality of heat radiating spokes extending out from the hub for facilitating the transfer of heat to the outer surface of the roller. A hollow sleeve member with a velvet outer surface is arranged over the core member. First and second end rings are attached to the core member at the ends of the roller; each of these rings has a flange extending over, but spaced from the adjacent end portion of the velvet-covered outer surface of the sleeve member.

### BACKGROUND OF THE INVENTION

This invention is a set of electrically-heated hair curling rollers intended for private use in the home or for commercial use in beauty salons. The curler set is to be unique in the area of the size of the curlers and the amount of curlers included in the set.

In the production area of this invention, the following SIC codes are potentially applicable:

3634 Electric housewares and fans

3999 Miscellaneous manufacturing industries

3079 Miscellaneous plastics products

Although there are several electrically-heated hair curling roller sets on the market today, this set is unique in the size of the curler set and the number of curlers included in the set. Most electrically-heated curling roller sets on the market today contain a limited number of curlers, such as 14, that force the purchase of a second set in order to have enough curlers to use to set the hair. Also, most electric curler sets today have graduated sizes of curlers which causes there to be a limited amount of the needed size of a particular curler, again causing the consumer to purchase a second set in order to have enough of the needed size of any particular curler.

### DETAILED DESCRIPTION OF THE INVENTION

The invention is a set of electrically-heated hair curling rollers to be used by either beauty salons or for home use. The set of curlers will include forty (40) curlers approximately ¾″ in diameter and approximately 3½″ in length, non-graduated sizes, which is completely different from any hair curling set on the market today. Most electric hair curler sets today have only fourteen to twenty curlers in them. The curler set will be encased in a plastic casing.

The unit has a heart-shaped plastic casing with twenty-three curler receptacles around the outer edge, seventeen curler receptacles forming an inner heart, and a central heart-shaped clip storage case with a brass handle in the center. Each curler receptacle contains a tubular rod that is connected to a central heating element. Placed over each rod is a miniature curler approximately ¾ of an inch in diameter and 3½ inches long.

The trademark name “Little Sweetheart Mini Twenties” is printed in gold letters across the top of the heart-shaped lid. The base of the unit has three cylindrical brass legs, and has an electric cord, with the 3-prong grounding plug, that is to be plugged into any standard outlet.

To use the electrically-heated hair curling roller set, simply plug the cord into an electrical outlet and allow the curlers to heat. After a designated length of time, the curlers can be removed one at a time and used to roll sections of hair on the head. Clips can be taken as needed from the heart-shaped clip storage case in the center of the unit.

### BRIEF SUMMARY OF THE INVENTION

An electrically-heated hair curling roller set that contains forty miniature curlers. The unit has a heart-shaped casing with twenty-three curling roller receptacles around the outer edge, seventeen curling roller receptacles forming an inner heart, and a central heart-shaped clip storage case with a brass handle in the center. Each curler receptacle contains a tubular rod that is connected to a central heating element. Placed over each rod is a miniature curling roller approximately ¾ of an inch in diameter and 3½ inches long.

The trademark name “Little Sweetheart Mini Twenties” is printed in gold letters across the top of the heart-shaped lid. The base of the unit has three cylindrical brass legs. The hair curling roller set (Little Sweetheart Mini Twenties) also has an electric cord that is to be plugged into any standard outlet.

To use the electrically-heated hair curling roller set, simply plug the cord into an electrical outlet and allow the curlers to heat. After a designated length of time, the curlers can be removed one at a time and used to roll sections of hair on the head. Clips can be taken as needed from the heart-shaped clip storage case in the center of the unit.

### BRIEF DESCRIPTION OF THE VIEWS OF THE DRAWINGS

Following the Specification are drawings of the electric hair curler set and casing.

FIG. 1 is an elevational view of the hair curling roller set showing the tubular rods ending in heart-shaped tops (no. 1); also showing the handle (no. 2) of the plastic carrying case; the second level (3) of the carrying case in which the tubular rods rest; the base (no. 4) of the carrying case which houses the heating element that heats the tubular rods on which the outer curler sits; the extension of the carrying case handle (no. 5); and the electrical plug fitted into the base of the curler set and protudes from the base of the curler set outward (no. 6).

FIG. 2 shows the outer view of the carrying case with the trademark and the heart-shaped picture.

FIG. 3 shows the top outside view of the packaging of the electricallyj-heated hair curler set with the trademark name and picture.

FIG. 4 contains the side outside view of the packaging of the electrically-heated hair curler set with the trademark name and picture.

FIG. 5 is a perspective view of the hair curling roller set showing the location of the tubular rods, the handle of the case, the clip storage, placement of the legs on the casing, and position of the rollers.

FIG. 6 is a side view of the hair curling roller set indicating the placement of each tubular rod, the clip storage for securing the curler to the hair, the handle of the carrying case and the position of the three legs on the carrying case.

FIG. 7 is a picture showing the curling rollers as they are to be placed inside the heart-shaped casing; showing the middle of the casing as the storage unit for the clips which hold the hair curling roller to the hair.

FIG. 8 is a picture showing the depth of the casing wherein the base of the casing will hold the central heating element that is connected to each tubular rod on which the outer velvet-covered core member rests; showing also the middle of the casing which is the clip storage for the hair curling rollers.

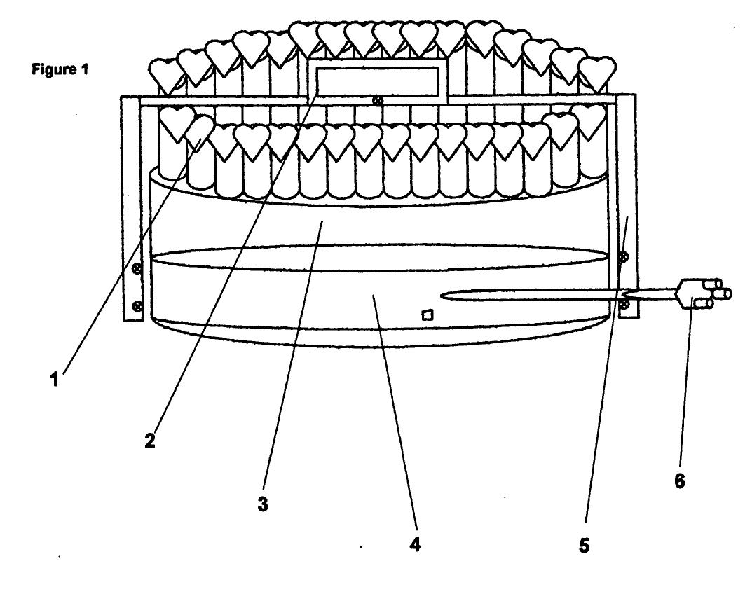

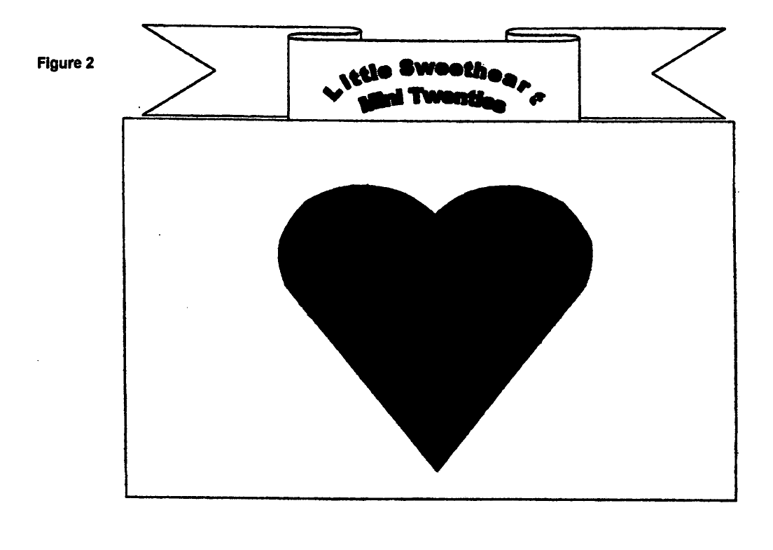

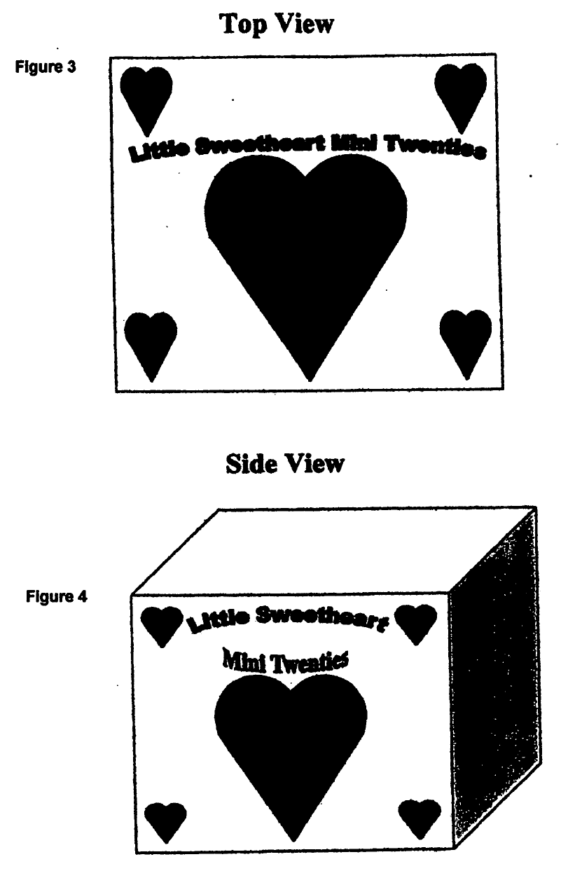

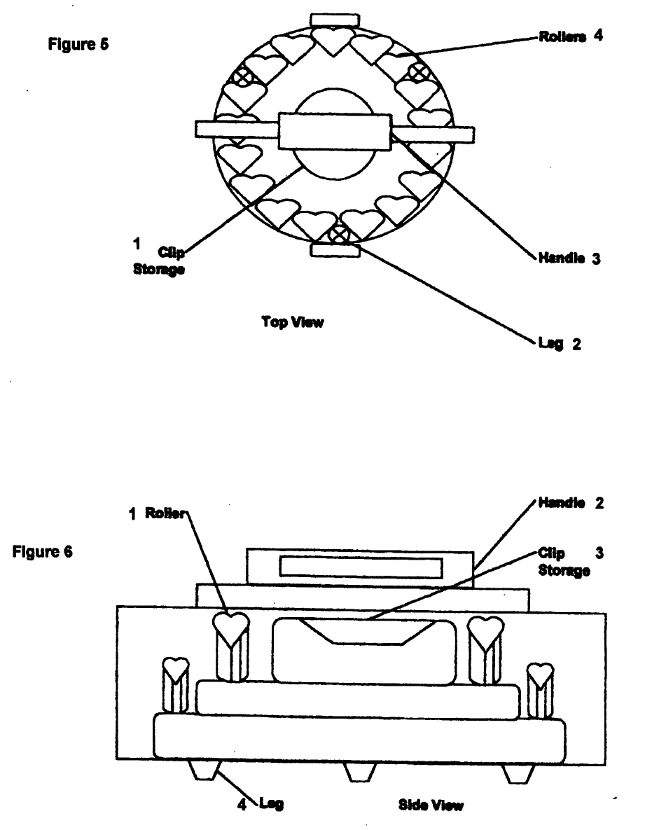

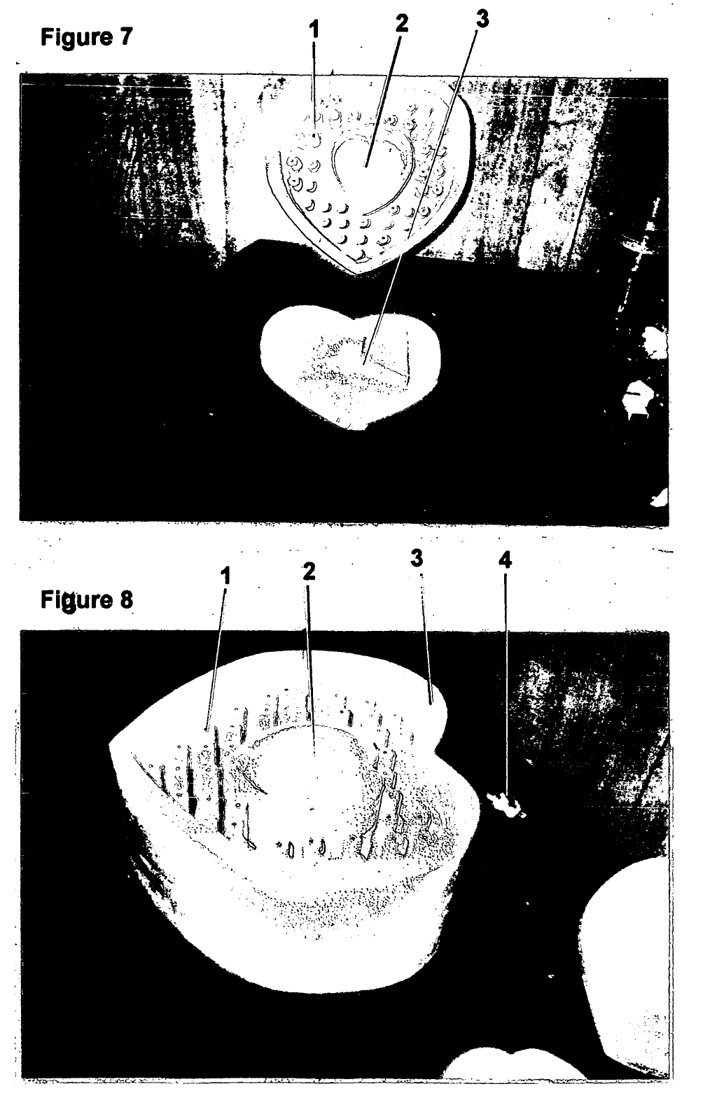

What is claimed is:

1. A hair curling roller system comprising:
a plastic housing
a plurality of tubular rods arranged within said housing and being capable of generating heat in the hair rollers that will be placed on the said tubular rods, all of the said tubular rods of the said system being of the same diameter;
a plurality of rollers for curling hair, each of the said rollers having an inner core means with an extending inner cavity, an outer surface for contact with the hair to be rolled and a metal sleeve arranged within said inner cavity.
a first group of said rollers arranged along the outer wall of the inside of the housing, with a second group of said rollers arranged along the inner section of the housing and around the clip storage; both sets of said rollers being the same diameter in size, with said inner cavities fitting onto the tubular rods that radiates heat and said inner cavities being of the same diameter, each of said rollers being capable of being arranged on one of the said tubular rods such that said tubular rod extends into said metal sleeve of the respective said roller;
said core means of each of said rollers of said second group of rollers including heat transfer means for facilitating the transfer of heat from its said inner cavity to its said outer surface so that when said rollers are heated the level of heat on the outer surface of all of said rollers is approximately the same;

2. A system wherein each of said heat transfer means in the said rollers includes a cylindrical hub surrounding said inner cavity and a plurality of spokes arranged around said hub and extending outward from said hub with spaces remaining between adjacent spokes.

3. A system wherein each of the said rollers has an outer sleeve and each said outer sleeve is coated with velvet material so that the outer surface of each of said rollers is a vevet-covered outer surface.

4. A system wherein each of the said rollers has flanges on its longitudinal ends, said flanges extending over, but are spaced from said velvet-covered outer surface, and said flanges are formed of a low heat conducting material.

5. A roller for curling hair comprising:
a hollow outer sleeve having a velvet-covered surface;
a central core member having an opening in one lateral end of said core member and extending upward within said core member and said core member being formed of a highly-heat-conductive material;
a metal sleeve arranged with upward extending opening in said core member;
a plurality of spokes attached to and extending in an outward direction from said core member, said spokes being formed of a highly-heat-conductive material and being spaced around said core member and separated from each other for facilitating transfer of heat from said central core member to said hollow outer sleeve member; and said hollow outer sleeve member being arranged around and being adjacent to said spokes.

6. A roller further comprising an end ring attached to said core member at one end, having a flange extending over, but spaced from the adjacent end portion of said velvet-covered outer surface of said sleeve member; and, another end ring attached to said core member at opposite end, having a flange extending over, but spaced from the adjacent end portion of said velvet-covered outer surface of said sleeve member.

7. A roller wherein both said end rings are formed of a low heat-conducting material.

8. A roller wherein said openings in said core member extends through said core member from one end surface to the other end surface;

9. A roller wherein said opening in said core member is of a sufficient diameter and extends for a sufficient length from one surface end to the other surface end to enable said roller to be arranged on a heat conductive tubular rod for transmitting heat to said roller.

10. A roller wherein said velvet-covered material is formed of a cotton material.
